(19) United States
(12) Patent Application Publication
(10) Pub. No.: US 2011/0040588 A1
(43) Pub. Date: Feb. 17, 2011

(54) VIRTUAL MEETING AGGREGATOR SYSTEM AND METHOD

(75) Inventors: Lisa L. Durocher, Warren, NJ (US); Danielle Elizabeth Puceta, Brooklyn, NY (US); Krista Keturah Stein, New York, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Epress Travel Related Services Company, Inc., New York, NY (US)

(21) Appl. No.: 12/626,364

(22) Filed: Nov. 25, 2009

Related U.S. Application Data
(60) Provisional application No. 61/234,258, filed on Aug. 14, 2009.
(60) Provisional application No. 61/234,585, filed on Aug. 17, 2009.

(51) Int. Cl. G06Q 10/00

(52) U.S. Cl. 705/7

(57) ABSTRACT

A meeting aggregator system and method enables the formulation of various meeting plan options, analysis of the return on investment and costs associated with each option. The meeting aggregator system accesses an inventory of meeting facilities (e.g., telepresence facilitites, web conference rooms, conference rooms for live meetings, etc.). The meeting aggregator accesses a variety of data sources and implements custom cost calculations to consider travel costs, cultural factors, environmental factors, travel policies and user preferences. A decision tool provides users access to interactive planning, analysis and resource booking.

### CROSS REFERENCE TO RELATED APPLICATIONS

This application claims priority to, and the benefit of, U.S. Provisional Application Ser. No. 61/234,258, entitled “Virtual Meeting Aggregator System and Method” and filed Aug. 14, 2009 and this application also claims priority to, and the benefit of, U.S. Provisional Application Ser. No. 61/234,585, entitled “Virtual Meeting Aggregator System and Method” and filed Aug. 17, 2009. All of the above-listed applications are incorporated herein by reference.

### FIELD OF INVENTION

The present invention generally relates to optimizing resources and schedules, and more particularly, to a meeting aggregator system and method for enabling analysis and decisions associated with meeting planning.

### BACKGROUND

Modern technology revolutionized the way that people meet and communicate. In many instances, traditional meetings are now being replaced, partially replaced, or enhanced by some form of a technology assisted meeting or virtual meeting. Virtual meeting technology exists in a variety of forms and includes, for example, conference calling, video conferencing, web meeting (e.g., webex) and telepresence solutions. Telepresence refers to a set of technologies that allow users not only to communicate, but to actually receive stimuli that makes them feel as if they are in the presence of other users. For instance, telepresence solutions often include life size video images of the other participants. In recent years, several providers such as Cisco, Hewlett-Packard (HP), and Polycom have developed specialized hardware in order to provide telepresence solutions. In addition to specialized hardware, a telepresence service may also require connectivity (i.e., network) suppliers, space providers, and meeting planning and coordination service providers. For more information regarding telepresence see generally, Cisco Systems Inc., San Jose, Calif. which offers the Public Cisco TelePresence™ or Cisco TelePresence™. The Cisco TelePresence helps people meet, share content, create high-quality video recordings and events, consult with experts and deliver powerful personalized services (www.cisco.com/TelePresence) and/or Polycom, Inc., Pleasanton, Calif. which offers the Polycom Telepresence Solutions (www.Polycom.com/Telepresence).

Virtual meetings potentially provide huge cost and time savings. However, at the same time, the analysis of comparing both the direct and indirect costs savings of conducting a virtual meeting versus a face to face (or “live”) meeting may be complex. The lack of easily accessible, accurate cost analysis data prevents organizations from fully embracing virtual meetings as a viable alternative to live meetings, from making an investment in virtual meeting infrastructure and/or from maximizing the benefits of an investment in virtual meeting technology and services by motivating people to use such virtual meeting technology. Thus, a long-felt need exists to provide a virtual meeting decisioning support system that provides detailed cost analysis and comparison and other virtual meeting logistical support.

### SUMMARY

The methods and systems disclosed herein enable analysis and decisions associated with meeting planning. The systems may include a meeting aggregator, analysis and decision tool. The meeting aggregator computer has access to meeting facility inventory (e.g., meeting facility capabilities and availability), travel planning resources, cost and pricing data, environmental data (e.g., carbon dioxide emissions savings), profile data, etc. The meeting aggregator determines options that meet the needs of the proposed meeting, while optimizing other objectives such as return on investment (ROI) of a meeting facility or asset and/or meeting effectiveness (e.g., matching a meeting format to cultural factors or local custom).

In one embodiment, a meeting aggregator computer receives a request to create a meeting plan for a meeting with any number of attendees. The request may include, for example, desired meeting facility(s), location(s), travel plan, costs, etc. The meeting aggregator computer (in conjunction with other system components such as a central data repository) determines a plurality of meeting options to satisfy the meeting request by considering, for example, resource (e.g., telepresence facility) availability, attendee preferences (e.g., prefer not to travel) and company guidelines (e.g., company officer level meetings should be conducted face-to-face or “live”). Each of the meeting options identify a format (or a combination of formats) for which the meeting will be conducted. Meeting formats include, for example, telepresence meeting, web conference, live meeting, and teleconference.

The meeting aggregator computer performs an analysis of each of the meeting options for return on investment (ROI) of a telepresence investment. For instance, a company who is hosting the meeting may own a telepresence facility (e.g., meeting room, technology assets, etc) and ROI on the investment is improved by maximizing utilization of the facility. The costs associated with each of the options are calculated and analyzed. For instance, the meeting aggregator computer may determine travel costs, facility rental costs, environmental impact of travel vs. non-travel etc. The user (e.g., customer service representative and/or meeting planner from a company) is provided a report by the meeting aggregator computer that details the options and the costs associated with the options.

### BRIEF DESCRIPTION OF THE DRAWINGS

A more complete understanding of the present inventions may be derived by referring to the detailed description and claims when considered in connection with the Figures, wherein like reference numbers refer to similar elements throughout the Figures, and:

FIG. 1A is a block diagram illustrating a high level conceptual design for enabling a meeting aggregator, in accordance with an exemplary embodiment of the present invention;

FIG. 1B is a block diagram illustrating major system components for enabling a meeting aggregator, in accordance with an exemplary embodiment of the present invention;

FIG. 2 is a diagram showing the various entities interacting with the meeting aggregator, in accordance with an exemplary embodiment of the present invention;

FIG. 3 is a diagram showing a user interface for a analysis and decision making, in accordance with an exemplary embodiment of the present invention;

FIG. 4 is a diagram showing a user interface presenting cost data, in accordance with an exemplary embodiment of the present invention.

### DETAILED DESCRIPTION OF EXEMPLARY EMBODIMENTS

The systems and methods improve upon existing systems by providing a tangible, integrated, online virtual meeting aggregator system (VMAS). An embodiment of the invention may be implemented by a system, computer readable medium or a method or any combination thereof. The VMAS enables detailed cost analysis and decision support for meeting planning, enhances productivity, increases employee satisfaction and boosts collaboration. VMAS provides more sophisticated cost and savings analysis (e.g., price, duration of trip, purpose of trip, environmental impact, etc.) and better resource prioritization analysis. For organizations that conduct meetings, VMAS provides a broader pool of meeting options, while providing advice and reports to ensure that every meeting yields the highest return, whether the meeting is live, conference call, video conference, web based meeting (webex), virtual in a private facility, virtual in a public facility, or any combination thereof. For an organization that has already invested in virtual meeting capabilities by, for instance, purchasing telepresence equipment and other assets, VMAS enables the organization to maximize return on investment by driving utilization of the internal or private telepresence assets.

While the embodiments described herein are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a user interface (UI), a software module, logic engines, numerous databases and computer networks. While the system may contemplate upgrades or reconfigurations of existing processing systems, changes to existing databases and system tools are not necessarily required by the present invention.

While the description references specific technologies, hardware, equipment, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as personal digital assistants. In that regard, the system may allow booking a meeting, access to the meeting or initiation of the technology by the user submitting its account number and other data via a webpage.

“Entity” may include any individual, consumer, consumer, group, business, organization, government entity, transaction account issuer or processor (e.g., credit, charge, etc), merchant, consortium of merchants, consumer, account holder, charitable organization, software, hardware, and/or any other entity.

An “account”, “account number” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account. The system may include or interface with any of the foregoing accounts or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

A “transaction account” may include any account that may be used to facilitate a financial transaction.

A “financial institution” or “issuer” includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

A “financial processor,” “payment network,” or “payment system” or may include any entity which processes transactions, issues accounts, acquires financial information, settles accounts, conducts dispute resolution regarding accounts, and/or the like. As one of ordinary skill will recognize a financial account issuer may operate as, and provide the functions and services of a financial processor.

A “merchant” may include any person, entity, software and/or hardware that receives payment or other consideration. For example, a merchant may request payment for services rendered from a consumer who holds an account with a transaction account issuer.

An “item” may include any good or service. For example a merchant, may sell an item to a consumer and the consumer may provide payment for the item using a transaction account (e.g. a credit card).

A “user” may include any person, entity, software and/or hardware that interacts with a system and/or participates in a process. For instance, user 105 may perform tasks such as requesting, retrieving, receiving, updating, analyzing, entering and/or modifying cost analysis data. User 105 may interface with Internet server 125 via any communication protocol, device or method discussed herein, known in the art, or later developed. User 105 may be, for example, any person, a customer service representative (“CSR”) providing virtual meeting aggregation, analysis and support or an employee (e.g. a meeting planner and/or a traveler) using a VMAS online tool to conduct virtual meeting cost analysis and planning.

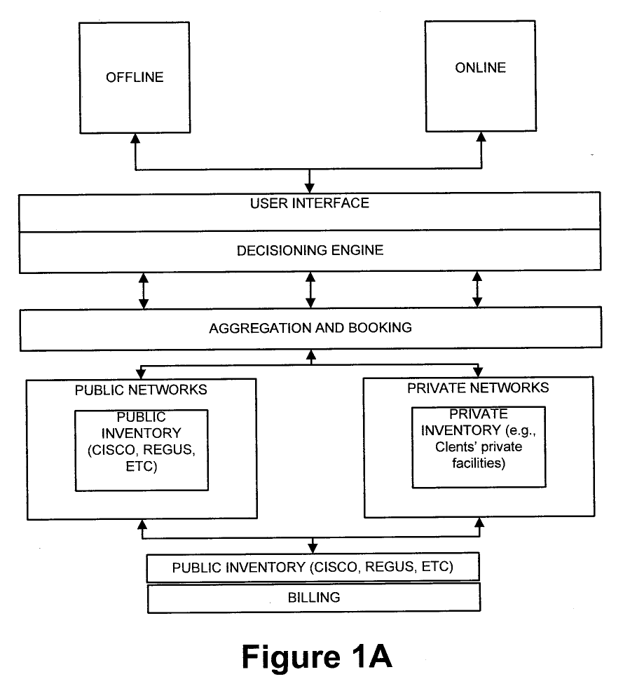

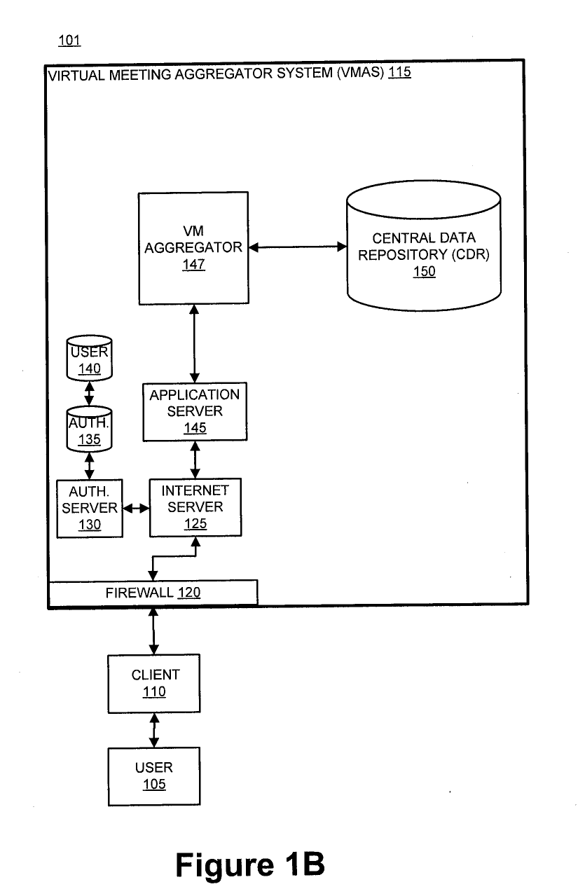

FIG. 1A shows an embodiment of a high level conceptual design for enabling a virtual meeting aggregator. A virtual meeting online tool may include, for example, a user interface, descisioning engine, aggregation and booking module, billing and reporting modules and access to public and private inventories of meeting resources (e.g., telepresence facility, conference room, etc.).

With reference now to FIG. 1B, in one embodiment system 101 includes a user 105 interfacing with a virtual meeting aggregator system (“VMAS”) 115 by way of a client 110. VMAS 115 is an integrated system comprised of various subsystems, modules and databases. Client 110 comprises any hardware and/or software suitably configured to facilitate requesting, retrieving, updating, analyzing, entering and/or modifying data. The data may include communication data (e.g. audio, video, text), verification data, authentication data, cost data, historical data, profile data, demographic data, transaction data, or any information discussed herein. Client 110 includes any device (e.g., personal computer), which communicates (in any manner discussed herein) with the VMAS 115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 110 may or may not be in direct contact with VMAS 115. For example, the client 110 may access the services of VMAS 115 through another server, which may have a direct or indirect connection to Internet server 125. User 105 may communicate with the VMAS 115 through a firewall 120 to help ensure the integrity of the VMAS 115 components. Internet server 125 may include any hardware and/or software suitably configured to facilitate communications between the client 110 and one or more VMAS 115 components.

Firewall 120, as used herein, may comprise any hardware and/or software suitably configured to protect VMAS 115 components from users of other networks. Firewall 120 may reside in varying configurations including stateful inspection, proxy based and packet filtering, among others. Firewall 120 may be integrated as software within Internet server 125, any other system 101 component, or may reside within another computing device or may take the form of a standalone hardware component.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140. Application server 145 may include any hardware and/or software suitably configured to serve applications and data to a connected client 110.

VMAS 115 is a fully integrated system comprised of various subsystems, modules and databases. With reference again to FIG. 1B, VMAS 115 combines and allows communication with a central data repository (“CDR”) 150 and various other portals and UN (not shown in FIG. 1B).

Virtual meeting place engine (“VMP Engine”) 147 is a software module configured to enable online functions such as receiving query requests, configuring responses, dynamically configuring user interfaces, requesting data, receiving data, displaying data, performing cost comparison and analysis, performing resource planning and scheduling, prompting user 105 with security challenges, verifying user responses, authenticating the user, initiating VMAS 115 processes, initiating other software modules, encrypting and decrypting. Additionally, VMP Engine 147 may include any hardware and/or software suitably configured to receive requests from client 110 via Internet server 125 and the application server 145. VMP Engine 147 is further configured to process requests, execute transactions, construct database queries, and/or execute queries against databases, within system 101 (e.g., central data repository (“CDR”) 150), external data sources 161 and temporary databases.

VMP Engine 147 is configured to exchange data with other systems and application modules. In one embodiment, the VMP Engine 147 may be configured to interact with other system 101 components to perform complex calculations, retrieve additional data, format data into reports, create XML representations of data, construct markup language documents, construct, define or control UIs, and/or the like. Moreover, VMP Engine 147 may reside as a standalone system or may be incorporated with the application server 145 or any other VMAS 115 component as program code. For example, VMP Engine 147 may access (e.g., in real-time) virtual meeting place (e.g. telepresence facility) inventory data and execute business rules. VMP Engine 147 may include functionality to allow customer 205 to (e.g., in real time) browse meeting inventory, browse content, and compare rates, while also booking guest rooms, meeting space, catering and audio visual equipment. As one of ordinary skill in the art will appreciate, VMP Engine 147 may be logically or physically divided into various subcomponents such as a workflow engine configured to evaluate predefined rules and to automate processes associated with a virtual meeting place implemented in VMP 115.

In addition to the components described above, system 101, and VMAS 115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Client 110 may include an operating system (e.g., Windows XP, Windows NT, 95/98/2000, XP, Vista, 0S2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In an embodiment, access is through a network or the Internet through a commercially available web-browser software package. Client 110 and VMAS 115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 110 and/or any of the system components may include wired and/or wireless portions.

Internet server 125 may be configured to transmit data to client 110 within markup language documents. “Data” may include encompassing information such as commands, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, application server 145 may communicate with any number of other servers, databases and/or components through any means known in the art. Further, application server 145 may serve as a conduit between client 110 and the various systems and components of VMP 115. Internet server 125 may interface with application server 145 through any means known in the art including a LAN/WAN, for example. Application server 145 may further invoke software modules such as the VMP Engine 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 1B depicts databases that are included in an exemplary embodiment of the invention. An exemplary list of various databases used herein includes: an authentication database 135, a user database 140, CDR 150 and/or other databases that aid in the functioning of the system. As practitioners will appreciate, while depicted as separate and/or independent entities for the purposes of illustration, databases residing within system 101 may represent multiple hardware, software, database, data structure and networking components. Furthermore, embodiments are not limited to the exemplary databases described herein, nor do embodiments necessarily utilize each of the disclosed exemplary databases.

Authentication database 135 may store information used in the authentication process such as, for example, user identifiers, passwords, access privileges, user preferences, user statistics, and the like. User database 140 maintains user information and credentials for VMAS 115 users (e.g., user 105).

CDR 150 is a data repository that is configured to store a wide variety of comprehensive data. While depicted as a single logical entity in FIG. 1B, those of skill in the art will appreciate that CDR 150 may, in some embodiments, consist of multiple physical and/or logical data sources. In one embodiment, CDR 150 stores meeting room data, content data, historical data, transaction data, configuration data, geographic data, user profile data, schedules, security profiles, audit records, predefined rules, process definitions, financial data, and the like.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Referring again to FIG. 1B, in one embodiment, when user 105 logs onto an application Internet server 125 may invoke an application server 145. Application server 145 invokes logic in the VMP Engine 147 by passing parameters relating to the user's 105 requests for data. VMAS 115 manages requests for data from VMP Engine 147 and communicates with system 101 components. Transmissions between user 105 and Internet server 125 may pass through a firewall 120 to help ensure the integrity of VMAS 115 components. Practitioners will appreciate that the invention may incorporate any number of security schemes or none at all. In one embodiment, Internet server 125 receives requests from client 110 and interacts with various other system 101 components to perform tasks related to requests from client 110.

Internet server 125 may invoke an authentication server 130 to verify the identity of user 105 and assign roles, access rights and/or permissions to user 105. In order to control access to the application server 145 or any other component of VMP 115, Internet server 125 may invoke an authentication server 130 in response to user 105 submissions of authentication credentials received at Internet server 125. When a request to access system 101 is received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

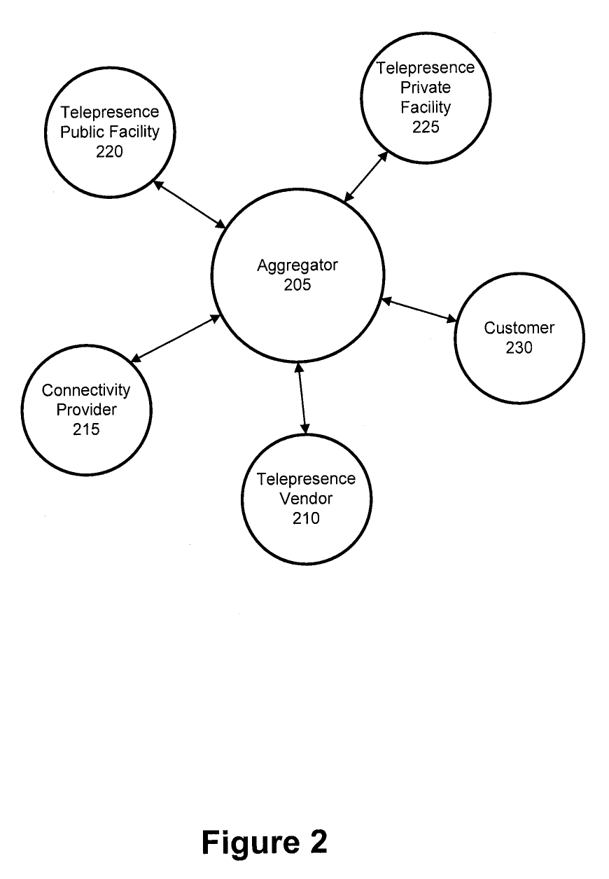

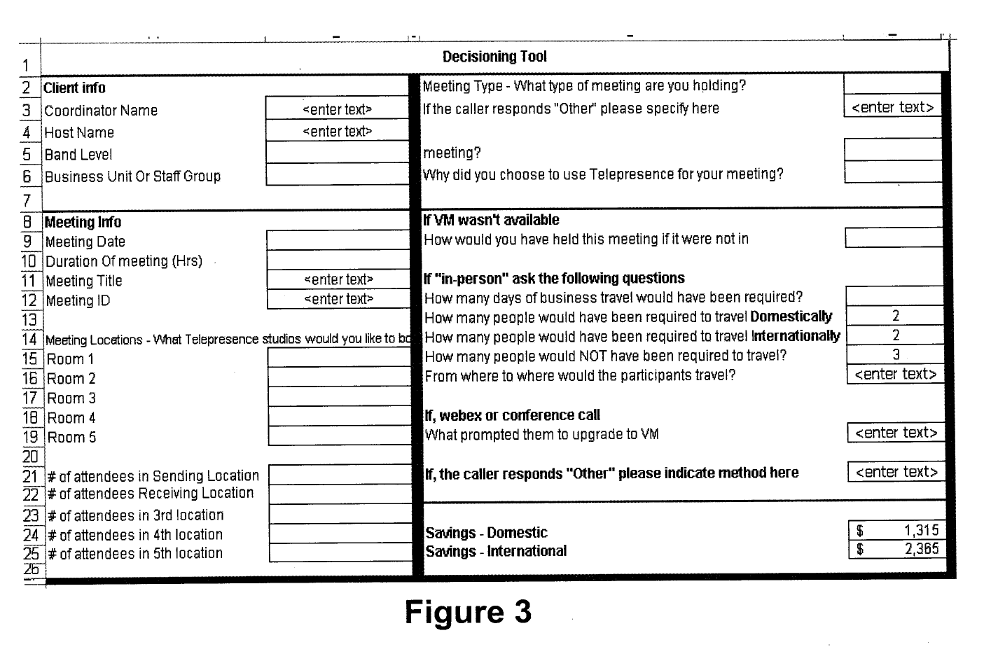

Referring now to FIG. 2, the entities that may participate in a virtual meeting solution (e.g., telepresence) are shown. In one embodiment, aggregator 205 is VMAS 115 and customers 230 are users 105 of VMAS 115. In one embodiment, aggregator 205 is a CSR accessing VMAS 115 to conduct cost and decision analysis for customer 230. An example of one embodiment of a CSR decisioning tool is shown in FIG. 3. The CSR collects data from customer 230 and conducts an interactive cost, meeting plan and/or logistical analysis. In one embodiment, a virtual meeting decisioning support system provides detailed cost analysis and comparison and allows users to book either traditional travel, meetings services (e.g., conference room or conference call bridge) and/or book for a live virtual meeting inventory. The live virtual meeting inventory aggregates both private company availability as well as public availability.

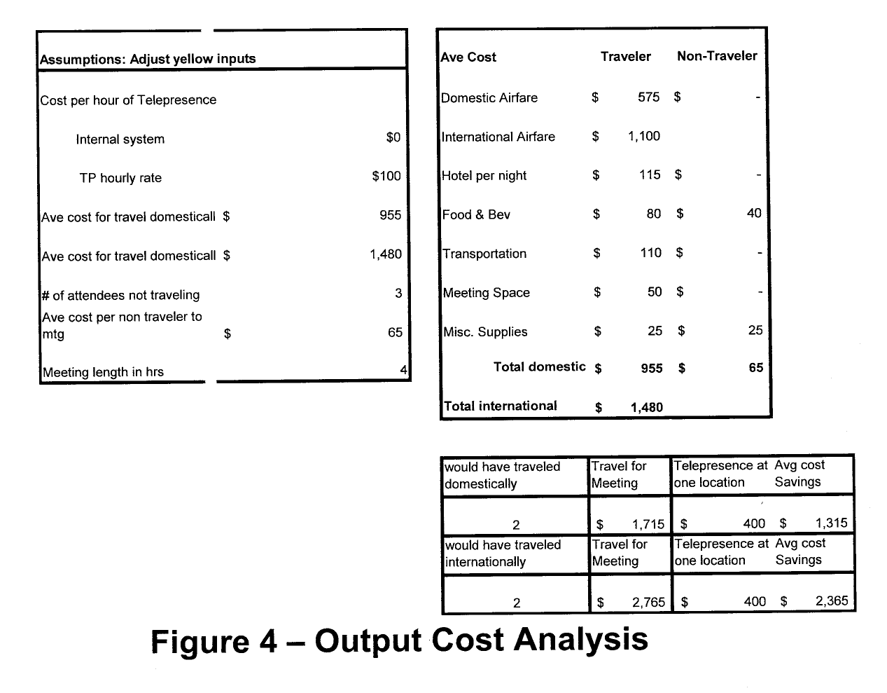

In one embodiment (not shown in FIG. 2), CSR collects information regarding a customer's 230 environmental or “green” initiatives in order to integrate environmental cost and savings factors into the analysis and recommendations. FIG. 4, shows one example of a cost savings output produced by VMAS 115.

In one embodiment, customer 205 may access VMAS 115 directly. For example, a member of the finance department at a large corporation may access VMAS 115 applications and/or web portal services, to determine the most cost effective way to conduct a large meeting with participants from several continents. In one embodiment, VMAS 115 provides customer 205 (e.g., a meeting planner and/or a traveler) with a connection to conduct (e.g., in real-time) meeting cost analysis and logistical planning (e.g., by browsing meeting inventory, browsing content, comparing rates and/or booking guest rooms, meeting space, catering and audio visual equipment).

Telepresence vendor 210 provides equipment and technology services to a telepresence facility and connectivity provider 215 provides network data communications services from a telepresence facility to another facility and/or another data network.

Telepresence public facility 220 is a facility capable of providing telepresence services that is available for rental by customer 205. For example, a hotel (e.g., Marriott) or other vendor (e.g., Kinko's) may host a telepresence facility at one of their locations and allow the general public to lease the telepresence facility for a specified period of time. In one embodiment, telepresence public facility 220 is accessible only to a customer with an existing relationship with telepresence public facility or are a preferred customer, VIP customer, etc. In one embodiment, the telepresence public facility 220 is available to be rented to the general public but a certain subset (e.g., preferred customers) are given scheduling priority. Telepresence private facility 225 includes telepresence facilities that are available for use only by a particular entity. For instance, a large corporation may own and operate several Telepresence private facilities 225 for use only for the corporations business needs. In one embodiment, a Telepresence private facility 225 may offer unused facility time to the public (semi-private telepresence facility).

VMAS 115 includes sophisticated data acquisition, data analysis, logistical planning, cost optimization and recommendations output modules. In one embodiment, VMAS 115 is a meeting aggregator computer that accesses data from a variety of data sources to aid in determining an optimal meeting plan solution for a customer 230. In an embodiment, customer 230 may wish to plan a meeting for a large number of geographically dispersed participants. Options for conducting such a meeting include a live meeting where all participants are physically present in the same location for the meeting, a virtual meeting where all participants use a virtual meeting technology to conduct the meeting or a hybrid meeting where some participants are co-located and others access the meeting virtually. In one embodiment, VMAS 115 accesses an inventory or meeting facilities (e.g., telepresence facility, web conference room, etc), which is acquired from various data sources and stored in CDR 150. As one skilled in the art will appreciate VMAS 115 is not limited to performing analysis and planning for a large meeting such as the one discussed in the above example. For instance, VMAS may be used to analyze options, evaluate costs and plan meetings with two participants.

The full cost of a live meeting may be difficult to determine without the proper data and analysis tools. For instance, a rough estimate of the cost for one participant to attend a meeting may include an estimate of the cost of travel (e.g., airfare), the cost of lodging, the cost of meals and the cost of local transportation (e.g., taxis, subways, etc.). In one embodiment, VMAS 115 accesses historical travel, company expense, lost productivity and/or transaction account data to enhance the cost analysis for conducting a meeting. In one embodiment, VMAS 115 accesses account issuer data (e.g., from a transaction card company) to analyze detailed and granular data regarding historical and forecasted customer spending habits. VMAS 115 may also access travel service data (e.g., from a travel agent database) to analyze detailed and granular data regarding historical and forecasted customer travel preferences and habits. In one embodiment, VMAS 115 is owned and/or operated by an account issuer. For more information regarding the tools and data available to account issuers see, e.g., disclosure of methods and apparatus for calculating the size of wallet in U.S. patent application Ser. No. 11/169,588 which was published with publication number 2006-0242046 A1 and U.S. patent application Ser. No. 11/586,737 which was published with publication number US 2007-0226130 A1, both of which are hereby incorporated by reference in their entirety.

For instance, detailed analysis of a participant's spending habits may indicate that when the participant travels to New York for a meeting, the participant tends to spend large sums of money on unnecessary meals and entertainment (e.g., baseball games, Broadway shows). VMAS 115 may access transaction account data from an account issuer, accounts payable data from a company's accounting system and travel data from a travel account with a travel agent to aid in the cost analysis. Additionally, VMAS 115 may access travel policy, meeting planning and other organizational policies to determine a meeting plan and/or cost analysis for a given meeting plan. Furthermore, in one embodiment, VMAS 115 access travel industry data and tools (e.g. SABRE) to determine the cost of hotels, flights, etc. for each proposed participant of a meeting. In one embodiment, VMAS 115 accesses environmental data, (e.g. via a state or Federal environmental database) to obtain carbon emissions, carbon footprint, carbon or environmental credits, or other green or environmental data in order to conduct an environmental impact analysis of various meeting plan options (e.g., the environmental “cost” or impact of taking a flight to New York vs. attending a meeting virtually).

In addition to providing a more accurate cost estimate for attending a live meeting, VMAS 115 also accesses data to assess the cost and feasibility of conducting a virtual meeting. In one embodiment, VMAS 115 accesses telepresence facility scheduling data and pricing to determine the availability and cost of a telepresence facility in one or more locations. VMAS 115 analysis tools also include simulation and/or optimization software that enables VMAS 115 to combine cost considerations and logistical constraints in order to determine an optimal configuration for a meeting (“meeting plan”). Furthermore, as a true aggregator of data, VMAS 115 can take into account the technological capabilities of multiple telepresence or other virtual meeting facilities, the personal preferences of individual participants, corporate meeting policies, and budget constraints of multiple customers 230 or of different departments within the same customer 230.

For example, for a proposed 100 participant meeting in New York, VMAS 115 may determine that i) 35 participants from Northern California should travel to San Francisco to attend the meeting via customer's 205 Telepresence Private Facility 225, ii) due to cheap airfare, the high cost of a Telepresence Public Facility 220 in Chicago and a history of low spending habits in New York, 25 participants from Illinois and Wisconsin should fly to New York to attend the meeting live, iii) 30 participants from New York should attend the meeting live, iv) 15 participants from Florida should sign-up to use company's Telepresence Private Facility 225 in Miami but due to historical usage of in that site there is a 15% chance that company's 205 executives will schedule a higher priority meeting and render the Miami Telepresence Private Facility 225 unavailable, and iv) French participants should attend the meeting using a Paris Telepresence Public Facility 220. VMAS 115 output for this example may include cost analysis for each participant, total cost comparisons for live vs. virtual options for each participant, cost and facility utilization statistics for the telepresence facilities. Furthermore, VMAS 115 coordinates with the telepresence facilities and other service providers to ensure availability of the resources needed for any meeting plan solution.

VMAS 115 provides further value to customer 230 by providing alternative considerations (e.g., meeting plan options). In one embodiment, VMAS 115 accesses corporate data (e.g., of a customer 205) to determine the effectiveness of conducting a certain type of meeting using a certain virtual meeting technology. For instance, historical data may indicate that finance meetings are conducted effectively via conference call (a relatively low-cost solution) or web meeting, while strategic marketing meetings (e.g., with sample marketing brochures) are ineffective via conference call, but work well via telepresence virtual meeting, and that client presentations must be conducted via a live meeting. Furthermore, institutional and/or cultural data sources are accessed by VMAS 115 to determine whether certain cultures or geographic areas are more or less inclined to relate to a virtual meeting format. For example, in the example described above, the cost analysis (i.e., item iv.) showed that the French participants should participate via teleconference, however, in an effectiveness analysis VMAS 115 may adjust its recommendation if data indicates that Europeans are not yet comfortable with the telepresence format.

VMAS 115 provides further benefit and value to customer 230 by providing other cost and/or benefit considerations such as optimizing contractual usage obligations and providing the functionality for loyalty points associated with any step or feature of the system discussed herein. For example, VMAS 115 tracks telepresence facility usage and customer 230 purchases of a tiered pricing contract for telepresence facility usage. Thus, the cost analysis and/or cost forecast may change depending on a specific usage contract and the customer 230 current and planned facility usage. In one embodiment, the cost analysis factors include a preference to use a private telepresence facility over a public facility. For example, if the telepresence facility is owned or operated by customer 230, by a preferred vendor, or under a contractual relationship beneficial to customer 230, the true or fully realized cost of using the private facility may be much lower, than using the public facility option.

In one embodiment, VMAS 115 enables customer 230, participants, vendors, merchants, affiliated companies, related parties and the like to derive additional benefit for using the telepresence (or other virtual meeting facility). VMAS 115 tracks loyalty point accumulation in association with one or more loyalty programs and may suggest a meeting plan that benefits and/or optimizes accumulation of loyalty points. VMAS may also operate its own loyalty program or award its own set of loyalty points (e.g., that may be converted into other loyalty system points, or vice versa). Loyalty points may be awarded for saving money, conducting a certain number of virtual meetings, having virtual meetings at certain locations, getting a certain number of people to attend virtual meetings, conducting a successful meeting, increasing environmental benefits by conducting a virtual meeting and/or the like. For more information regarding loyalty points programs, see for example, U.S. Ser. No. 10/027,984 filed on Dec. 20, 2001 and entitled System And Method For Networked Loyalty Program, U.S. Pat. No. 7,467,096 issued on Dec. 16, 2008 and entitled System And Method For The Real-Time Transfer Of Loyalty Points Between Accounts, U.S. Ser. No. 11/161,906 filed on Aug. 22, 2005 and entitled Card Member Discount System And Method, and U.S. Ser. No. 11/382,638 filed on May 10, 2006 and entitled System And Method For A Merchant Loyalty System, the entirety of which are hereby incorporated by reference.

In one embodiment, VMAS 115 (and/or aggregator 205) tracks and provides optimization recommendation to telepresence facility owners/operators. In one embodiment, VMAS 115 includes complex priority rules that aid in the scheduling and utilization management of a telepresence facility. For example, a private telepresence facility 225 may be a located at a large corporation and access to the facility may be prioritized according to a pre-determined hierarchy. VMAS 115 accesses the hierarchy and assesses availability of the facility based upon the hierarchy. In one embodiment, when a higher priority meeting threatens to displace (i.e., “bump”) a lower priority meeting, customer 230 is presented with a cost analysis showing the cost ramifications of canceling the lower priority meeting. In one embodiment, hierarchical priority allows preferential scheduling, but does not allow a higher priority meeting to “bump” a lower priority meeting if the lower priority meeting is within a predetermined lock-in date.

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention.

It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Plural may also include a singular embodiment. Moreover, when a phrase similar to “at least one of A, B, and/or C” is used, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. A method, comprising:
receiving, at a meeting aggregator computer, a request to create a meeting plan for a meeting of attendees;
determining, by the meeting aggregator computer, a plurality of meeting options based on the request, resource availability, attendee preferences and company guidelines, wherein the plurality of meeting options comprise a meeting format comprising at least one of telepresence meeting, web conference, live meeting, and teleconference;
determining, by the meeting aggregator computer, a subset of the plurality of meeting options based on return on investment (ROI) of a first telepresence investment;
determining, by the meeting aggregator computer, costs associated with each of the plurality of options related to the meeting plan; and
providing, by the aggregator computer, a report including the subset of the plurality of meeting options and the costs.

2. The method of claim 1, wherein the request includes attendee information comprising the locations of attendees and at least one of a level for a subset of the attendees, an affiliation for a subset of the attendees, travel preferences a level for a subset of the attendees, and company travel guidelines for a subset of the attendees.

3. The method of claim 1, wherein the request includes meeting requirements comprising at least one of meeting room requirements, audio capability, video capability, interne connectivity, computer, a video screen size, a maximum number of locations, a minimum number of locations, and language translation requirements.

4. The method of claim 1, further comprising forecasting the impact of each option in the plurality of meeting options on the ROI of the first telepresence investment.

5. The method of claim 1, wherein the first telepresence investment comprises at least one of an ownership of a telepresence facility, a telepresence technology asset, a telepresence facility lease, and a telepresence service provider contract.

6. The method of claim 1, wherein the first telepresence investment includes a tiered pricing contract associated with a telepresence service provider.

7. The method of claim 1, wherein the ROI is at least partially based upon at least one of maximizing the utilization of a telepresence facility, maximizing the revenue generated by a telepresence facility and maximizing loyalty points associated with using a telepresence facility.

8. The method of claim 1, further comprising obtaining airline schedule and pricing information.

9. The method of claim 1, wherein resource availability is determined at least partially by a probabilistic assessment of the likelihood of losing a reservation for a meeting facility, wherein the losing the reservation comprises losing the reservation due to another meeting taking precedence.

10. The method of claim 1, wherein costs comprise travel costs comprising at least one of airfare, lodging, local transportation, meals and location specific spending habits.

11. The method of claim 1, wherein the costs comprise determining at least one of the costs associated with a first attendee not attending the meeting, the costs associated with changing the date and the costs associated with changing the time of the meeting.

12. The method of claim 1, wherein costs comprise location specific spending habits, and wherein the location specific spending habits are at least one of included in the request and stored in a central data repository.

13. The method of claim 1, wherein the meeting aggregator computer accesses a central data repository comprising facility profile data, client profile data and company profile data.

14. The method of claim 1, further comprising providing a user interface for registration, wherein the registration comprises registering at least one of a facility, a client and a company.

15. The method of claim 1, further comprising providing a meeting plan decision tool, wherein the meeting plan decision tool comprises a user interface for at least one of submitting a request, specifying meeting constraints and entering cost factors.

16. The method of claim 1, further comprising providing a meeting plan decision tool, wherein the meeting plan decision tool comprises viewing the plurality of options related to the meeting plan and choosing a preferred meeting option from the plurality of options.

17. The method of claim 1, wherein the report comprises at least one of average cost per attendee, average cost per company, a cost comparison between two options resource utilization and travel itineraries for a preferred option, wherein the preferred option is one of the subset of the plurality of meeting options.

18. The method of claim 1, wherein the subset of the plurality of meeting options is further determined at least partially upon the ROI of a second telepresence investment.

19. The method of claim 1, further comprising sending to a service provider a request to at least one reserve a teleconference facility, reserve a flight for an attendee, reserve a hotel room for an attendee and reserve a vehicle for an attendee.

20. The method of claim 1, further comprising determining an environmental cost by at least one of calculating a carbon footprint, acquiring environmental data from a service provider, and accessing a government database, wherein the costs include the environmental cost.

21. The method of claim 1, further comprising determining benefits associated with each of the plurality of options related to the meeting plan.

22. The method of claim 1, further comprising determining cultural factors for each of the telepresence options, wherein the cultural factors comprise at least one of language factors, religious factors, and local customs.

23. A tangible computer-readable medium having computer-executable instructions stored thereon that, if executed by a payment management computer, cause the payment management computer to perform a method comprising:
receiving a request to create a meeting plan for a meeting of attendees;
determining a plurality of meeting options based on the request, resource availability, attendee preferences and company guidelines, wherein the plurality of meeting options comprise a meeting format comprising at least one of telepresence meeting, live meeting, and teleconference;
determining a subset of the plurality of meeting options based on return on investment (ROI) of a first telepresence investment;
determining costs associated with each of the plurality of options related to the meeting plan; and
providing a report including the subset of the plurality of meeting options and the costs.

24. A system comprising:
a network interface communicating with a meeting aggregator computer comprising a memory, a processor and a computer program; and
the processor, when executing the computer program, is configured to:
receive a request to create a meeting plan for a meeting of attendees;
determine a plurality of meeting options based on the request, resource availability, attendee preferences and company guidelines, wherein the plurality of meeting options comprise a meeting format comprising at least one of telepresence meeting, live meeting, and teleconference;
determine a subset of the plurality of meeting options based on return on investment (ROI) of a first telepresence investment;
determine costs associated with each of the plurality of options related to the meeting plan; and
provide a report including the subset of the plurality of meeting options and the costs.
